(19) United States
(12) Patent Application Publication
(10) Pub. No.: US 2026/0073889 A1
(43) Pub. Date: Mar. 12, 2026

(54) DEVICE AND METHOD FOR CORRECTING IMAGE QUALITY OF DISPLAY DEVICE

(71) Applicant: SAMSUNG ELECTRONICS CO., LTD., Suwon-si (KR)

(72) Inventor: Hyoungwoo CHOI, Suwon-si (KR)

(73) Assignee: SAMSUNG ELECTRONICS CO., LTD., Suwon-si (KR)

(21) Appl. No.: 19/279,348

(22) Filed: Jul. 24, 2025

Related U.S. Application Data
(63) Continuation of application No. PCT/KR2025/009720, filed on Jul. 7, 2025.

(30) Foreign Application Priority Data
Sep. 10, 2024 (KR) 10-2024-0122907

(51) Int. Cl. G09G 5/00

(52) U.S. Cl. CPC G09G 5/003; G09G 2300/026; G09G 2340/0407; G09G 2354/00; G09G 2360/144

(57) ABSTRACT

An electronic device may receive an image via the transceiver, to be displayed on a display device including a first display area set to a first resolution and a second display area set to a second resolution, set a resolution of a boundary area between the first display area and the second display area to a third resolution based on the first resolution and the second resolution, and transmit the received image and information about the third resolution to the display device. The first resolution may be set based on a first pixel pitch of the first display area. The second resolution may be set based on a second pixel pitch of the second display area. The second pixel pitch may be different from the first pixel pitch.

### CROSS-REFERENCE TO RELATED APPLICATION(S)

This application is a continuation of an International Application No. PCT/KR2025/009720 designating the United States, filed on Jul. 7, 2025, in the Korean Intellectual Property Receiving Office, which claims priority from Korean Patent Application No. 10-2024-0122907, filed on Sep. 10, 2024, in the Korean Intellectual Property Office, the disclosures of each of which are incorporated by reference herein in their entireties.

### BACKGROUND

One or more embodiments of the present disclosure relate to a device and a method for controlling the image quality of a display device.

Recently, there has been a growing trend in display technology toward creating screens of various sizes by combining multiple modular displays. Each modular display included in a display device can operate independently or be connected with others to form screens of different sizes and shapes. By adding or removing modular displays, the display device can adjust the screen's size and aspect ratio as needed. Based on their flexibility and scalability, these displays are suitable for a wide range of applications. For instance, they can serve as high-end home TVs, outdoor digital signage, or large videowalls for stages or exhibition venues.

Modular display-based display devices are experiencing rapid growth across various industries and are expected to become even more widespread as the technology continues to advance. While these devices offer outstanding image quality and performance, they also demand high precision, which leads to increased manufacturing and installation costs. Thus, there is a growing need for methods to reduce the overall cost of these display devices.

### SUMMARY

An embodiment of the disclosure may provide a device and method for correcting the image quality of a display device.

An embodiment of the disclosure may provide a device and a method that perform image quality correction considering the visual characteristics of a user.

An embodiment of the disclosure may provide a device and a method that perform image quality correction based on the viewing environment or the viewing distance.

An embodiment of the disclosure may provide a device and a method that may reduce manufacturing and installation costs of display devices while maintaining image quality through image quality correction.

According to an embodiment, an electronic device may include: a transceiver; memory; and at least one processor, wherein the at least one processor is configured to execute instructions stored in the memory to: receive an image, via the transceiver, to be displayed on a display device including a first display area set to a first resolution and a second display area set to a second resolution; set a resolution of a boundary area between the first display area and the second display area to a third resolution based on the first resolution and the second resolution; and transmit the received image and information about the third resolution to the display device. The first resolution may be set based on a first pixel pitch of the first display area, the second resolution may be set based on a second pixel pitch of the second display area, and the second pixel pitch may be different from the first pixel pitch.

According to an embodiment, the first pixel pitch may be less than the second pixel pitch, the first display area may be determined based on at least one of a screen size of the display device, a viewing angle of a user viewing the display device, or a viewing distance of the user, and the second display area may be determined to be a remaining area except for the first display area in a screen of the display device.

According to an embodiment, the display device may include a plurality of modular displays, and the plurality of modular displays are included in the first display area and the second display area.

According to an embodiment, the at least one processor may be configured to execute the instructions to: identify a content type of content included in the received image by analyzing the received image based on a machine learning model that is trained to identify the content type based on a still image or a video; and set the resolution of the boundary area to the third resolution based on the content type not corresponding to a set type, wherein the set type indicates content having a subject positioned at a center of a screen of the display device or content associated with static imagery.

According to an embodiment, the at least one processor may be configured to execute the instructions to: determine an area within the first display area, adjacent to the second display area, as the boundary area; and control the transceiver to transmit, to at least one modular display of the display device, information about the determined boundary area, the received image, or information about the third resolution. The at least one modular display may include at least a portion of the boundary area among a plurality of modular displays included in the display device.

According to an embodiment, the at least one processor may be configured to execute the instructions to set an average resolution of the first resolution and the second resolution as the third resolution.

According to an embodiment of the disclosure, a display device may include: a transceiver; a plurality of modular displays configured to form a first display area set to a first resolution and a second display area set to a second resolution; memory; and at least one processor, wherein the at least one processor is configured to execute instructions stored in the memory to: receive output information from an electronic device via the transceiver; based on first information included in the output information, identify a third resolution set for a boundary area between the first display area and the second display area; and control the display to display an image corresponding to second information included in the output information in the boundary area at the third resolution. The third resolution may be determined based on the first resolution and the second resolution, the first resolution may be set based on a first pixel pitch of the first display area, the second resolution may be set based on a second pixel pitch of the second display area, and the second pixel pitch may be different from the first pixel pitch.

According to an embodiment, the display device may include a first sensor, wherein the at least one processor may be configured to execute the instructions to: measure an illuminance value based on the first sensor, based on receiving the output information; and control the display to display the image corresponding to the second information in the boundary area at the third resolution based on the measured illuminance value being less than a threshold.

According to an embodiment, the display device may further include a second sensor, wherein the at least one processor may be configured to execute the instructions to: measure a distance from a user based on the second sensor, based on receiving the output information; and control the display to display the image corresponding to the second information included in the output information in the boundary area at the third resolution based on the measured distance being included in a set range.

According to an embodiment, the first pixel pitch may be less than the second pixel pitch, the first display area may be determined based on at least one of an entire screen size of the modular display device, a viewing angle of a user viewing the modular display device, or a viewing distance of the user, and the second display area may be determined to be a remaining area except for the first display area in an entire screen of the modular display device.

According to an embodiment of the disclosure, a method for operating an electronic device, may include: receiving an image to be displayed on a display device from a source device, the display device including a first display area set to a first resolution and a second display area set to a second resolution; setting a resolution of a boundary area between the first display area and the second display area to a third resolution determined based on the first resolution and the second resolution; and transmitting the received image and information about the third resolution to the display device. The first resolution may be set based on a first pixel pitch of the first display area, the second resolution may be set based on a second pixel pitch of the second display area, and the second pixel pitch may be different from the first pixel pitch.

According to an embodiment, the first pixel pitch may be less than the second pixel pitch, the first display area may be determined based on at least one of a screen size of the display device, a viewing angle of a user viewing the display device, or a viewing distance of the user, and the second display area may be determined to be a remaining area except for the first display area in a screen of the display device.

According to an embodiment, the display device may include a plurality of modular displays, and the plurality of modular displays are included in the first display area and the second display area.

According to an embodiment, the setting of the resolution of the boundary area to the third resolution may include: identifying a content type of content included in the received image by analyzing the received image based on a machine learning model that is trained to identify the content type based on a still image or a video; and setting the resolution of the boundary area to the third resolution based on the content type not corresponding to a set type. The set type indicates content having a subject positioned at a center of a screen of the display device or content associated with static imagery.

According to an embodiment, the method may include: determining an area within the first display area, adjacent to the second display area, as the boundary area; and transmitting, to at least one modular display of the display device, information about the determined boundary area, the received image, or information about the third resolution, wherein the at least one modular display may include at least a portion of the boundary area among a plurality of modular displays included in the display device.

According to an embodiment, the setting of the resolution of the boundary area to the third resolution may include setting an average resolution of the first resolution and the second resolution as the third resolution.

According to an embodiment of the disclosure, a method for operating a display device, may include: receiving output information from an electronic device, the display device including a plurality of modular displays that configure a first display area set to a first resolution and a second display area set to a second resolution; based on first information included in the output information, identifying a third resolution set for a boundary area between the first display area and the second display area; and displaying an image corresponding to second information included in the output information in the boundary area at the third resolution, wherein the third resolution may be determined based on the first resolution and the second resolution, the first resolution may be set based on a first pixel pitch of the first display area, the second resolution may be set based on a second pixel pitch of the second display area, and the second pixel pitch may be different from the first pixel pitch.

According to an embodiment, the identifying of the third resolution may include: measuring an illuminance value based on a first sensor included in the display device, based on receiving the output information; and displaying the image corresponding to the second information in the boundary area at the third resolution based on the measured illuminance value being less than a threshold.

According to an embodiment, the identifying of the third resolution may include: measuring a distance from a user based on a second sensor included in the display device, based on receiving the output information; and displaying the image corresponding to the second information in the boundary area at the third resolution based on the measured distance being included in a set range.

According to an embodiment, the first pixel pitch may be less than the second pixel pitch, the first display area is determined based on at least one of an entire screen size of the display device, a viewing angle of a user viewing the display device, or a viewing distance of the user, and the second display area may be determined to be a remaining area except for the first display area in an entire screen of the display device.

### BRIEF DESCRIPTION OF DRAWINGS

FIG. 1 is a block diagram illustrating a display system according to one or more embodiments.

FIG. 2 is a diagram illustrating a screen configuration of a display device according to an embodiment.

FIG. 3A is a diagram schematically illustrating a user's field of view according to an embodiment.

FIG. 3B is a diagram illustrating a user's visual characteristics according to an embodiment.

FIG. 3C is a diagram illustrating an operation of determining an area based on a user's visual characteristics according to an embodiment.

FIG. 4 is a diagram illustrating a boundary area of a display device according to an embodiment.

FIG. 5 is a block diagram illustrating a control device according to an embodiment.

FIG. 6 is a block diagram illustrating a modular display included in a display device according to an embodiment.

FIG. 7 is a flowchart illustrating an operation for correcting an image quality of a display device in a display system according to an embodiment.

FIG. 8 is a flowchart illustrating an operation of a control device according to an embodiment.

FIG. 9A is an example diagram illustrating a type of content according to an embodiment.

FIG. 9B is a flowchart illustrating operations of a control device for image quality correction of a display device according to an embodiment.

FIG. 10 is a flowchart illustrating operations of a modular display for image quality correction based on an illuminance value according to an embodiment.

FIG. 11 is a flowchart illustrating operations of a modular display for image quality correction based on a distance from a user according to an embodiment.

FIG. 12 is a diagram illustrating comparison between a single pitch screen and a multi-pitch screen according to an embodiment.

Reference may be made to the accompanying drawings in the following description, and specific examples that may be practiced are shown as examples within the drawings. Other examples may be utilized and structural changes may be made without departing from the scope of the various examples.

### DETAILED DESCRIPTION

Hereinafter, embodiments of the disclosure are described in detail with reference to the drawings so that those skilled in the art to which the disclosure pertains may easily practice the disclosure. However, the disclosure may be implemented in other various forms and is not limited to the embodiments set forth herein. The same or similar reference denotations may be used to refer to the same or similar elements throughout the specification and the drawings. Further, for clarity and brevity, description of well-known functions and configurations may be omitted in the drawings and relevant descriptions.

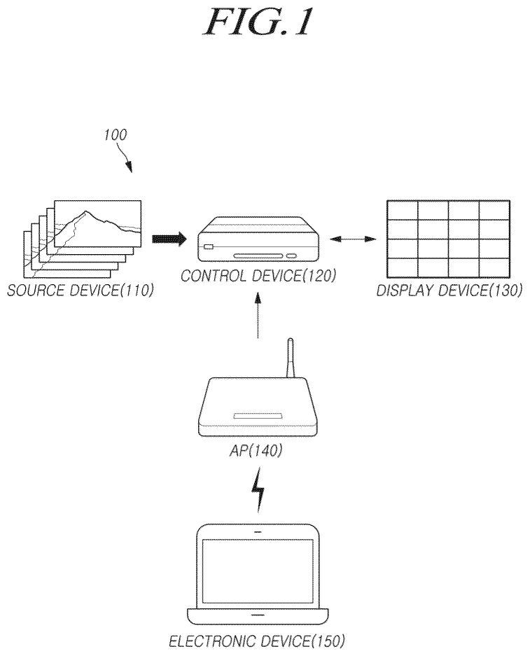

FIG. 1 is a block diagram illustrating a display system according to an embodiment.

Referring to FIG. 1, the display system 100 according to an embodiment may include a source device 110, a control device 120, a display device 130 including a plurality of modular displays, an access point (AP) 140, and an electronic device 150.

According to an embodiment, the source device 110 may provide source data (or image data) to the control device 120 for display on the display device 130. For example, the source data may include data associated with still images, videos, live streaming images, broadcast images, text, or a combination thereof. The source device 110 may be a mobile device (e.g., a smartphone or tablet), a wearable device (e.g., a smart watch, smart glasses, or a head mounted display (HMD)), a computer device (e.g., a personal computer (PC), a desktop, or a notebook), a home appliance (e.g., a TV), a camera, a media player, a real-time streaming device, or a server (e.g., a content server or a broadcast server), but the disclosure is not limited thereto.

According to an embodiment, the control device 120 may perform a control operation associated with the display device 130. Also referred to as a controller or a signage box (S-box), the control device 120 may be an electronic device that receives source data from the source device 110 and transmits it to the display device 130. In some embodiments, the control device 120 and the display device 130 may be combined into a single integrated electronic device.

According to an embodiment, the control device 120 may communicate with the display device 130 or each of a plurality of modular displays included in the display device 130.

According to an embodiment, the control device 120 may obtain display information (or display configuration information) via communication with the display device 130 or each of the plurality of modular displays. For example, the display information may include at least one of layout information (or position information such as coordinate information), pixel pitch information, resolution information, or area information about each of the plurality of modular displays. According to an embodiment, the control device 120 may perform various control operations related to the display operation of the display device 130 based on the obtained display information.

According to an embodiment, the control device 120 may communicate with the electronic device 150. For example, the control device 120 may perform Wi-Fi communication with the electronic device 150 via the AP 140, but is not limited thereto, and it may also be possible to perform communication with the electronic device 150 based on other wired or wireless communication. The control device 120 may be selectively connected to the electronic device 150, and may control the display device 130 according to an instruction of the electronic device 150. For example, if a message for changing attribute information (e.g., brightness information, color information, or resolution information) associated with at least one of the plurality of modular displays included in the display device 130 is received from the electronic device 150, the control device 120 may control at least one modular display to change the attribute information based on the received message.

According to an embodiment, the display device 130 may be a modular display device including a plurality of modular displays. Each of the plurality of modular displays may be a display device that may be independently driven, and they may be connected to be adjacent to each other to form a screen of the display device 130. The modular display device may be constructed by physically assembling the plurality of modular displays (e.g., referred to as tiles or panels), and the individual modular displays are configured to interconnect both mechanically and electronically, allowing them to operate together as a single, unified display system. The control device 120 may operate as a centralized controller to distribute image data and synchronize refresh rates across all modular display units. The plurality of modular displays may include various types of display panels such as a light emitting diode (LED), an organic light emitting diode (OLED), a quantum dot emitting diode (QLED), or a micro LED. Each of the plurality of modular displays may communicate with the control device 120. For example, the plurality of modular displays may display an image based on information and/or source data received from the control device 120.

According to an embodiment, the AP 140 may be used for connection between the control device 120 and the electronic device 150. The AP 140 may not be used when the control device 120 and the electronic device 150 perform other communication such as direct communication or wired communication.

According to an embodiment, the electronic device 150 may include a management program (or software or application) for controlling or managing the plurality of modular displays. For example, the management program may be used by a user to select or schedule an image to be displayed on each of the plurality of modular displays, to change state (e.g., on/off) or attribute information for each of the plurality of modular displays, or to control other setting information. The electronic device 150 may be a mobile device (e.g., a smartphone or tablet) or a computer device (e.g., a PC, a desktop, or a notebook), but may be another type of electronic device where the management program may be installed.

According to an embodiment, the electronic device 150 may be wirelessly or wiredly connected to the AP 140, and may communicate with the control device 120 via the AP 140. The electronic device 150 may transmit information input via the management program to the control device 120 for control of the display device 130.

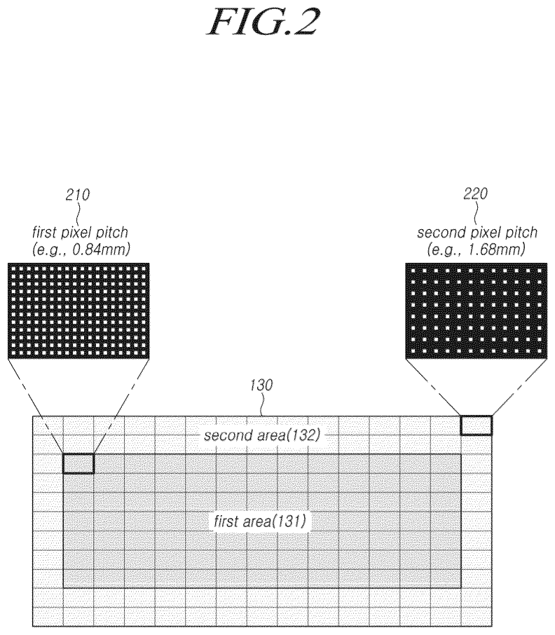

FIG. 2 is a diagram illustrating a screen configuration of a display device according to an embodiment.

Referring to FIG. 2, the screen of the display device 130 may be formed by the plurality of modular displays. For example, the screen of the display device 130 may have a rectangular shape by arranging the plurality of modular displays in a rectangular shape, but may have a different shape according to the arrangement of the plurality of modular displays.

According to an embodiment, the display device 130 may include at least two display areas on the screen. For example, the display device 130 may include a first display area 131 and a second display area 132. Hereinafter, for convenience of description, the first display area 131 is referred to as a first area 131, and the second display area 132 is referred to as a second area 132.

According to an embodiment, the first area 131 may correspond to a central area, defined or determined based on the user's visual characteristic (e.g., the user's field of view or central vision), and the second area 132 may correspond to an area different from the first area 131 on the screen of the display device 130, or the remaining area except for the first area 131. Information about the user's visual characteristics may be measured during calibration of the display device 130, performed under the control of the control device 120, and may be stored in the local memory of the control device 120. For example, the second area 132 may represents a region outside the first area on the screen of the display device 130, such as an edge area or a peripheral area surrounding the first area 131.

According to an embodiment, the first area 131 may be set to the first resolution based on a first pixel pitch 210, and the second area 132 may be set to the second resolution based on a second pixel pitch 220. The first pixel pitch 210 may refer to a spacing between pixels included in the first area 131 or a spacing between the centers of two adjacent pixels included in the first area 131. The second pixel pitch 220 may refer to a spacing between pixels included in the second area 132 or a spacing between the centers of two adjacent pixels included in the second area 132. The first pixel pitch 210 and the second pixel pitch 220 may affect the display resolution of each area, independent of any software-based image scaling or rendering techniques.

According to an embodiment, the first pixel pitch 210 and the second pixel pitch 220 may be different from each other. For example, the first pixel pitch 210 may be 0.84 mm, and the second pixel pitch 220 may be 1.68 mm. Since the first pixel pitch 210 is smaller than the second pixel pitch 220, the first area 131 may have a higher resolution than the second area 132. In the first area 131 based on the first pixel pitch 210, pixels may be disposed at a relatively high density to implement the first resolution, and higher image quality and detailed expression may be possible. In the second area 132 based on the second pixel pitch 220, pixels may be disposed at a relatively low density to implement the second resolution lower than the first resolution.

According to an embodiment, the screen of the display device 130 including areas (or modular displays) having different pixel pitches may be indicated as a multi-pitch screen.

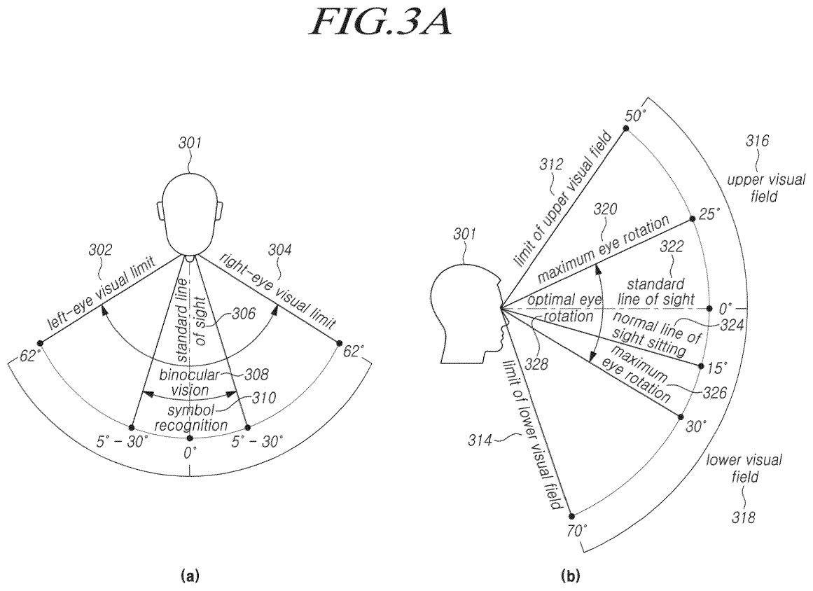

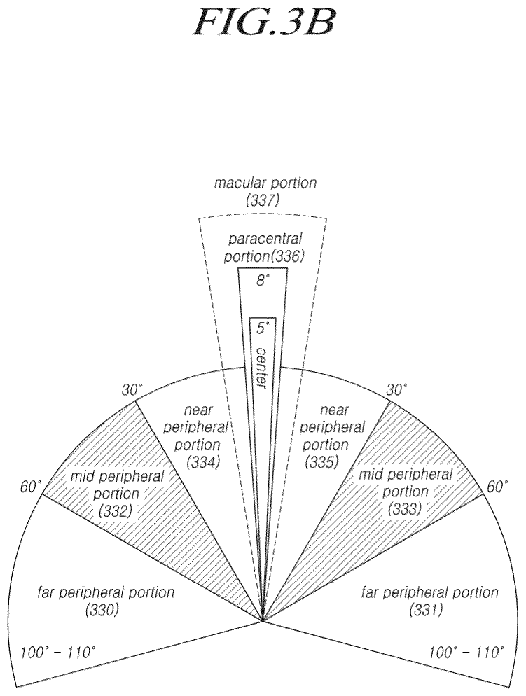

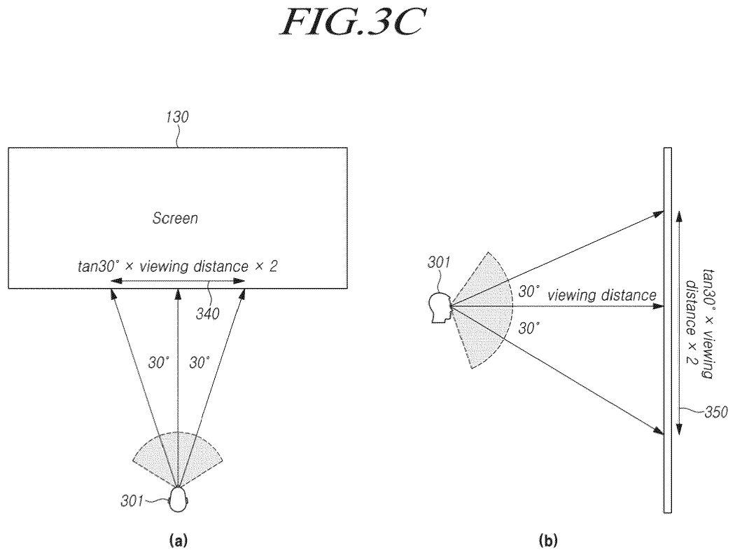

FIG. 3A is a diagram schematically illustrating a user's field of view according to an embodiment.

Referring to image (a) of FIG. 3A, the standard field of view of the user 301 in the left and right directions may indicate the left-right field of view (e.g., a horizontal visual range) in which the user 301 may see when both eyes fixed forward. The standard line of sight 306 associated with the standard field of view may indicate a straight line direction (e.g. a straight-ahead direction) of the user's gaze when the user 301 faces forward. The direction indicated by the standard line of sight 306 may correspond to a direction in which the user 301 may recognize the object most clearly.

A left-eye visual limit 302 and a right-eye visual limit 304 may be set in left and right directions with respect to the standard line of sight 306. The left-eye visual limit 302 may represent the maximum field of view (e.g., a maximum extent of the visual range) visible to the left eye, and the right-eye visual limit 304 may represent the maximum field of view visible to the right eye.

The standard field of view may include a range of binocular vision 308. The range of the binocular vision 308 may indicate a range in which the user 301 may conduct visual information processing (e.g., symbol recognition 310) using both eyes. The range of the binocular vision 308 may include, e.g., a range of a central field of view corresponding to 30 degrees left and right with respect to the standard line of sight 306. The remaining portion outside the range of the binocular vision 308 in the standard field of view may correspond to the peripheral field of view.

Referring to image (b) of FIG. 3A, the standard field of view of the user in the vertical direction may indicate the range of the vertical field of view in which the user 301 may see with both eyes fixed. The standard field of view 322 associated with the standard field of view may indicate a straight line direction indicated by the eyes and gaze when the user 301 faces forward. The direction indicated by the standard line of sight 322 may correspond to a direction in which the user 301 may recognize the object most clearly.

The standard field of view of the user 301 in the in the vertical direction may include an upper field of view (or upper visual field) 316 and a lower field of view (or lower visual field) 318. The upper field of view 316 may correspond to the upper side with respect to the standard line of sight 322, and may include a range from the standard line of sight 322 to the upper field of view limit (or limit of upper visual field) 312. The upper field of view limit 312 may represent the maximum field of view visible to the eyes in the in the upper direction.

The lower field of view 318 may correspond to the lower side with respect to the standard line of sight 322, and may include a range from the standard line of sight 322 to the lower field of view limit (or limit of lower visual field) 314. The lower field of view limit 314 may represent the maximum field of view visible to the eye in the lower direction.

The maximum eye rotations 320 and 326 may represent a maximum angle (e.g., 25 degrees in the upper direction or 30 degrees in the lower direction) at which the user 301's eyes may rotate in the vertical direction with respect to the standard line of sight 222. The maximum eye rotations 320 and 326 may be used to widen the visual range without the user 301 moving his or her head.

The optimum eye rotation 328 may represent a rotation angle in a range in which the user 301 may comfortably move the eyes, and may be included in a range of the maximum eye rotations 320 and 326.

The normal line of sight sitting 324 may represent a default gaze when the user 301 faces forward in a comfortable posture. For example, the normal line of sight sitting 324 may correspond to a direction facing down about 15 degrees with respect to the standard line of sight 322.

FIG. 3B is a diagram illustrating a user's visual characteristics according to an embodiment.

Referring to FIG. 3B, the field of view of the user 301 may be divided into a plurality of visual areas. For example, the user's field of view may include a macular portion 337, near peripheral portions 334 and 335, mid peripheral portions 332 and 333, and far peripheral portions 330 and 331.

The macular portion 337 may include a central portion and a paracentral portion 336. The central portion is an area associated with the central field of view, and may include a central area within about 5 degrees in the field of view. The central area is an area used when the user 301 directly stares at an object, and may have the highest visual resolution.

The paracentral portion 336 is an area surrounding the central portion, and may include an area in about 8 degrees in the field of view. The paracentral portion 336 may be a viewing area having a lower resolution than the central portion but providing a relatively clear view.

The near peripheral portions 334 and 335 are areas corresponding to a range in about 30 degrees from the central portion, and may be a viewing area for detecting an approximate shape and movement rather than a high-resolution detailed view.

The mid peripheral portions 332 and 333 may cover the range from about 30 to 60 degrees from the central portion. Visual resolution in the mid peripheral portions 332 and 333 may be lower compared to the central portion, and may be used for motion detection or shape recognition of a large object.

The far peripheral portions 330 and 331 may extend from about 60 degrees to 100˜110 degrees from the central portion. The far peripheral portions 330 and 331 may be used to detect a change in light or the position of a large object due to their low visual resolution.

As described above, the visual resolution of the user 301 may progressively decrease while the field of view expands outward from the macular portion 337 (or the center of the macular portion), through the near peripheral portions 334 and 335, the mid peripheral portions 332, 333, to the far peripheral portions 330 and 331.

FIG. 3C is a diagram illustrating an operation of determining an area based on a user's visual characteristics according to an embodiment.

Referring to FIG. 3C, the first area 131 of the display device 130 may include a vision area determined based on the visual characteristics of the user 301. The visual characteristics of the user 301 may include, e.g., the characteristic that the visual resolution or visual cognitive ability of the user 301 increases toward the central field of view and decreases away from the central field of view, as described in connection with FIGS. 3A and 3B.

According to an embodiment, the vision area may include a central field of view of the user 301, and may be determined based on the following Equation 1.

X or Y=tan 30°×viewing distance×2

tan 30°=1/\sqrt{3}=0.5773 [Equation 1]

In Equation 1, X may indicate the horizontal length 340 of the vision area, as illustrated in image (a) of FIG. 3C, and Y may indicate the vertical length 350 of the vision area, as illustrated in image (b) of FIG. 3C. tan 30° may be determined based on the viewing angle (e.g., 30°) of the user 301 in the vertical or horizontal direction with respect to a standard line of sight (e.g. the standard line of sight 306 illustrated in image (a) of FIG. 3A or the standard line of sight 322 illustrated in image (b) of FIG. 3A). For example, the viewing angle of the user 301 may include a viewing angle corresponding to a range in which the symbol recognition 310 is possible in image (a) of FIG. 3A, a range in the optimal eye rotation 328 in image (b) of FIG. 3A, or a range including the macular portion 337 and the near peripheral portions 334 and 335. The viewing distance may indicate a viewing distance of the user 301 viewing the display device 130. For example, the viewing distance may be determined based on at least one of the installation position of the display device 130, the installation environment, the arrangement space, the purpose of use, the type of use, or the characteristics of the content to be output.

According to an embodiment, the horizontal length 340 and the vertical length 350 of the vision area may be determined in the same manner based on X and Y determined based on Equation 1, but may be determined differently. For example, X and/or Y determined based on Equation 1 may be updated by adding a set value, and the updated X and/or Y may be used as the horizontal length 340 and/or vertical length 350 of the vision area. The set value is a value for extending the vision area, and may be determined based on, e.g., the movement or movement distance of the user 301 predicted in consideration of the installation environment.

According to an embodiment, the first area 131 may be determined based on the determination of the vision area on the screen of the display device 130.

According to an embodiment, an area different from the first area 131 in the screen of the display device 130 or the remaining area except for the first area 131 in the screen of the display device 130 may be determined as the second area 132.

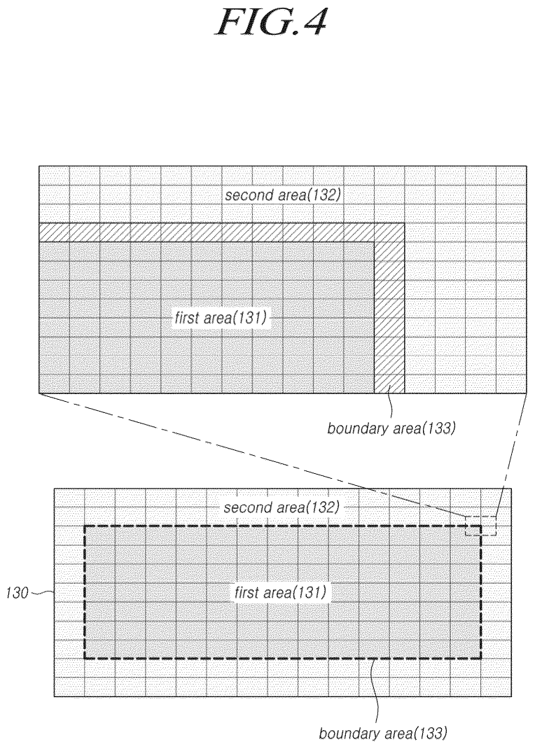

FIG. 4 is a diagram illustrating a boundary area of a display device according to an embodiment.

Referring to FIG. 4, a boundary area 133 may be included between the first area 131 and the second area 132 of the display device 130. According to an embodiment, the boundary area 133 may be determined by the control device 120 based on display information about each of the plurality of modular displays included in the display device 130. The control device 120 may receive display information from each of the plurality of modular displays.

According to an embodiment, display information about each of the plurality of modular displays may include arrangement information and/or area information.

According to an embodiment, the arrangement information about each of the plurality of modular displays may include information indicating the position where the corresponding modular display is arranged in the display device 130.

According to an embodiment, the area information about each of the plurality of modular displays may include information about an area where a plurality of module blocks included in the corresponding modular display are included. The area information may specify the spatial arrangement and grouping of a plurality of module blocks that form each respective modular display.

For example, the area information about the first modular display among the plurality of modular displays may include at least one of information indicating that the first module blocks included in the first modular display are located in the first area 131, information indicating that the pixels within the first module blocks are arranged according to the first pixel pitch, or information indicating that the first resolution is set for the first module blocks.

For example, the area information about the second modular display among the plurality of modular displays may include at least one of information indicating that the second module blocks included in the second module display are located in the second area 132, information indicating that the pixels within the second module blocks are arranged according to the second pixel pitch, or information indicating that the second resolution is set for the second module blocks.

For example, the area information about the third modular display among the plurality of modular displays may include at least one of, information indicating that at least one module block among the third module blocks included in the third modular display is located within the first area 131, while at least one other module block among the third module blocks is located within the second area 132, enabling a seamless transition between display areas with varying characteristics, information indicating that at least one module block includes pixels arranged according to the first pixel pitch (e.g., for high-resolution central vision support), information indicating that at least one other module block includes pixels arranged according to the second pixel pitch (e.g., for lower-resolution peripheral vision support), or information indicating that different resolutions are assigned to different module blocks within the third modular display, such that the first resolution is set for at least one module block and the second resolution is set for at least one other module block.

According to an embodiment, the control device 120 may identify module blocks adjacent to the second area 132 (or outermost modules of the first area 131) among module blocks included in the first area 131 based on arrangement information and/or area information about each of the plurality of modular displays, and determine an area corresponding to the identified module blocks as the boundary area 133. The module blocks within the boundary area 133 may have the same hardware structure (e.g., pixel pitch) as the module blocks in the first area 131, and the resolution of an image to be displayed in the boundary area 133 may be adjusted through image processing.

According to an embodiment, the number of rows or columns of module blocks constituting the boundary area 133 may be set to a minimum unit (e.g., one row or one column), or may be set by a user to a number greater than the minimum unit based on a management program.

According to an embodiment, the control device 120 may perform an image processing operation to correct or adjust the image quality of the boundary area 133. For example, the control device 120 may determine the resolution of the boundary area 133 as a third resolution based on the first resolution and the second resolution, so that an image of natural quality is output from the boundary area 133. The third resolution may be determined as an average resolution (or intermediate resolution) of the first resolution and the second resolution, but is not limited thereto, and may be determined as a resolution different from the average resolution between the first resolution and the second resolution. The third resolution may serve to blend the visual transition between the first area 131 and the second area 132, thereby producing a more seamless and visually natural output.

According to an embodiment, display device 130 may be implemented as a modular display device composed of a plurality of modular displays that together form a unified screen. The plurality of modular displays are divided or recognized into two regions: a central display area (e.g., the first area 131) and a peripheral display area (e.g., the second area 132). The central display area may include high-quality modular displays with a short pixel pitch, providing high-resolution output. These modular displays are more expensive and are positioned at the center of the overall display surface. In contrast, the peripheral display area may include lower-cost modular displays that have a longer pixel pitch and therefore offer a lower resolution. These modular displays may surround the central display area and may be used for content where less detail is acceptable, such as background graphics or peripheral information. By structuring the display device 130 in this way, the overall system achieves a balance between cost-efficiency and high-performance visual output.

According to an embodiment, to address the potential visual discontinuity between the high-resolution central display area and the lower-resolution peripheral display area, the boundary area 133 is located within the first area 131, near its interface with the second area 132. The boundary area 133 is physically part of the high-resolution region but is treated differently in terms of image resolution. For example, the display device 130 may dynamically set the resolution of the boundary area 133 to a third resolution that is lower than the resolution of the central display area, but higher than that of the peripheral display area. The third resolution may be determined based on the pixel pitches of the first and second areas (e.g., as an average or interpolated value) so that the transition between the two different resolutions becomes visually smoother. As a result, viewers may perceive a more natural and continuous display without an abrupt change in image clarity.

According to an embodiment, when an image is received, the control device 120 (e.g., a processor included in the control device 120) may identify the resolutions associated with the first and second areas 131, 132 based on their respective pixel pitches. The control device 120 then may calculate a suitable third resolution for the boundary area 133. The image, along with the resolution data, may be transmitted to the display device 130, ensuring that the image is rendered appropriately across all regions. For example, in a large digital signage installation at an airport, the central display area may operate at a 3840×2160 (4K) resolution with a 0.6 mm pixel pitch, while the surrounding peripheral area may operate at 1920×1080 resolution with a 1.2 mm pixel pitch. The boundary area, although physically located within the central display area with the 0.6 mm pixel pitch, may be displayed at an intermediate resolution (e.g., 2880×1620 resolution) to reduce the perceived contrast between the different display areas.

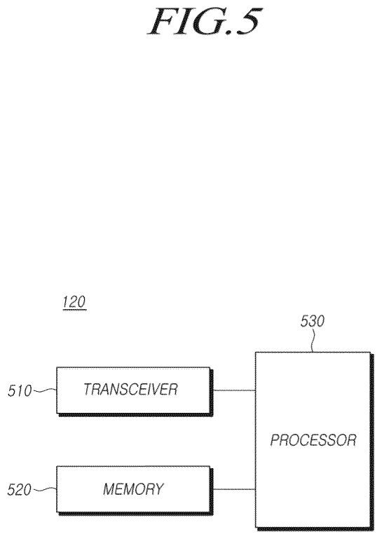

FIG. 5 is a block diagram illustrating a control device according to an embodiment.

Referring to FIG. 5, a control device 120 may include a transceiver (or communication interface) 510, memory 520, and a processor 530.

According to an embodiment, the control device 120 may include additional components (e.g., a user interface) other than the illustrated components, or may omit at least one of the illustrated components.

According to an embodiment, the transceiver 510 may support wired or wireless communication of the control device 120. For example, the transceiver 510 may support establishing a wired or wireless communication channel with a source device 110, a display device 130, or an electronic device 150, and/or performing communication via the established communication channel.

The transceiver 510 may be operated independently from the processor (e.g., an application processor) 530 and may include one or more communication processors that support wireless communication or wired communication. According to an embodiment, the transceiver 510 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via a first network (e.g., a short-range communication network, such as Bluetooth™, Bluetooth low energy (BLE), Wi-Fi, Wi-Fi direct (WFD), or infrared data association (IrDA)) or a second network (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

According to an embodiment, the memory 520 may store various data used by at least one component (e.g., the transceiver 510 or the processor 530) of the control device 120. For example, the memory 520 may store at least one program for processing and controlling the processor 530, and may store input and/or output data. The memory 520 may include a volatile memory or a non-volatile memory.

According to an embodiment, the processor 530 may control the overall operation of the control device 120. The processor 530 may perform control on at least one of the other components of the control device 120 and/or perform an operation or data processing relating to communication. For example, the processor 530 may be electrically connected to the display 310, the UI 320, and the memory 330 and may execute instructions of a program stored in the memory 330.

According to an embodiment, the processor 530 may include a processing circuit that executes instructions of the program stored in the memory 520. The processor 530 may include at least one of a central processing unit (CPU), a neural processing unit (NPU), a graphics processing unit (GPU), a micro processing unit (MPU), a micro controller unit (MCU), an application processor (AP), a communication processor (CP), a system on chip (SoC), or an integrated circuit (IC) sensor hub, a supplementary processor, an application specific integrated circuit (ASIC), or a field programmable gate arrays (FPGA), and may include a plurality of cores.

According to an embodiment, the processor 530 may control the operations of the control device 120 by executing the instructions stored in the memory 520. For example, the processor 530 may correspond to a plurality of processors that divide a plurality of operations between processors and collectively perform the operations.

According to an embodiment, the processor 530 may perform the operations of the control device 120 which have been described above or are to be described below.

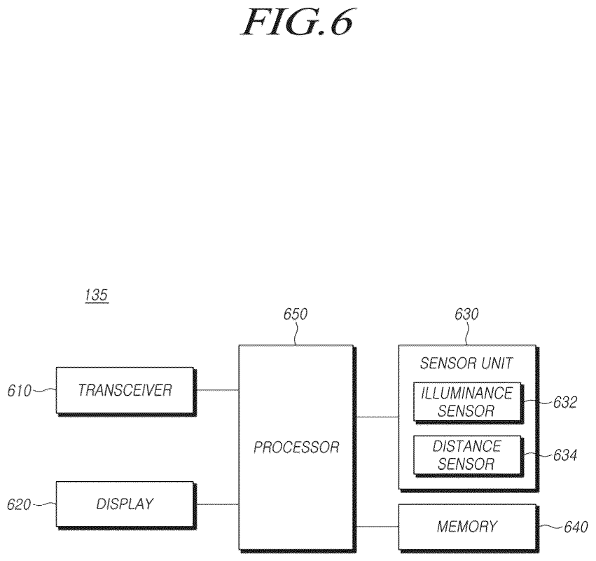

FIG. 6 is a block diagram illustrating a modular display included in a display device according to an embodiment.

Referring to FIG. 6, a modular display 135 may represent any one of a plurality of modular displays included in a display device 130, and may include a transceiver 610, a display 620, a sensor unit 630, memory 640, and a processor 650. According to an embodiment, the modular display 135 may include additional components (e.g., a user interface) other than the illustrated components, or may omit at least one of the illustrated components.

According to an embodiment, the transceiver 610 may support wired or wireless communication of the modular display 135. For example, the transceiver 610 may support establishing a wired or wireless communication channel with the control device 120, and/or performing communication via the established communication channel.

The transceiver 610 may be operated independently from the processor (e.g., an application processor) 640 and may include one or more communication processors that support wireless communication or wired communication. According to an embodiment, the transceiver 610 may include a wireless communication module (e.g., a cellular communication module, a short-range wireless communication module, or a global navigation satellite system (GNSS) communication module) or a wired communication module (e.g., a local area network (LAN) communication module or a power line communication (PLC) module). A corresponding one of these communication modules may communicate with the external electronic device via a first network (e.g., a short-range communication network, such as Bluetooth™, Bluetooth low energy (BLE), Wi-Fi, Wi-Fi direct (WFD), or infrared data association (IrDA)) or a second network (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other.

According to an embodiment, the display 620 may perform various display operations according to functions of the modular display 135. For example, display 620 may include a set number of module blocks that perform display operations and, based on the module blocks, display at least one of various service information, media information, text information, or broadcast information. According to an embodiment, the display 620 may display various images or contents transferred from the source device 110 via the control device 120.

According to an embodiment, the sensor unit 630 may include a plurality of sensors configured to detect information about the surrounding environment of the modular display 135. For example, the sensor unit 630 may include an illuminance sensor 632 and/or a distance sensor 634.

The illuminance sensor 632 may measure the intensity (or illuminance) of ambient light. The illuminance sensor 632 may convert ambient light into an electrical signal to determine the intensity or brightness level of the light.

The distance sensor 634 may measure a distance to an object (e.g., a person, a thing, an animal, a structure, or an obstacle). For example, the distance sensor 634 may include at least one of an ultrasonic sensor that measures the distance to the object by measuring the reflection time using ultrasonic signals, an infrared sensor that measures the distance to the object by detecting the reflection of the infrared signal from the object, and a time-of-flight (ToF) sensor that measures the distance to the object using light or laser pulses.

According to an embodiment, the memory 640 may store various data used by at least one component (e.g., the transceiver 610, the display 620, the sensor unit 630, or the processor 650) of the modular display 135. For example, the memory 640 may store at least one program for processing and controlling the processor 650, and may store input and/or output data. The memory 640 may store at least one artificial intelligence (AI) model (or machine learning model), and may include a volatile memory or a non-volatile memory.

According to an embodiment, the processor 650 may control the overall operation of the modular display 135. The processor 650 may perform an operation or data processing related to control and/or communication of at least one other component of the modular display 135. For example, the processor 650 may be electrically connected to the transceiver 610, the display 620, the sensor unit 630, and the memory 640 and execute instructions of a program stored in the memory 640.

According to an embodiment, the processor 650 may include a processing circuit that executes instructions of the program stored in the memory 640. The processor 650 may include at least one of a CPU, an NPU, a GPU, an MPU, an MCU, an AP, a CP, a SoC, an IC sensor hub, a supplementary processor, an ASIC, or an FPGA, and may have a plurality of cores.

According to an embodiment, the processor 650 may control the operations of the modular display 135 by executing the instructions stored in the memory 640. For example, the processor 650 may correspond to a plurality of processors that divide a plurality of operations between processors and collectively perform the operations.

According to an embodiment, the processor 650 may perform the operations of the modular display 135 which have been described above or are to be described below.

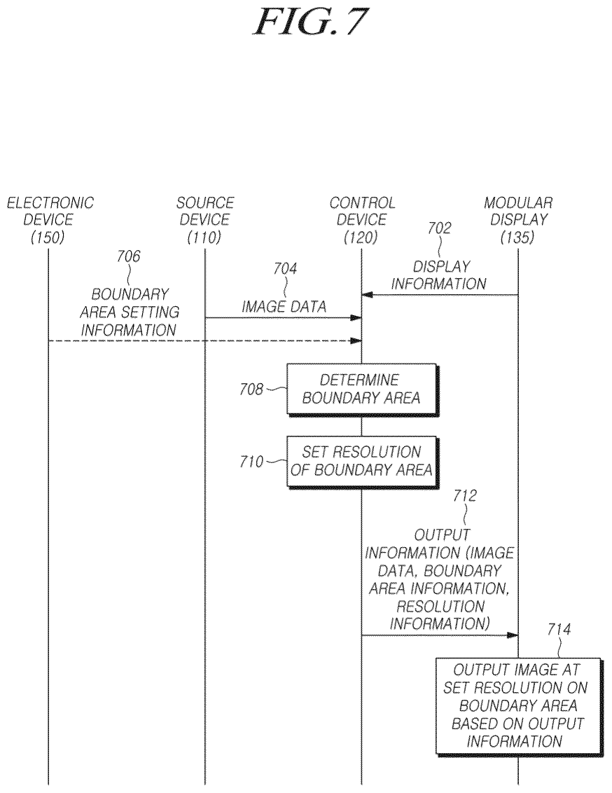

Hereinafter, operations of devices in a display system are described with reference to FIGS. 7 to 11. According to an embodiment, it may be understood that the operations of the control device 120 described in connection with FIG. 7, 8, or 9B are performed by the processor (e.g., the processor 530 of FIG. 5) of the control device 120. According to an embodiment, it may be understood that the operations of the modular display 135 described in connection with FIG. 7, 10, or 11 are performed by the processor (e.g., the processor 650 of FIG. 6) of the modular display 135. The operations illustrated in FIGS. 7, 8, and 9B to 11 may be performed in various orders without being limited to the illustrated order. According to an embodiment, at least some of the operations illustrated in FIGS. 7, 8, 9B to 11 may be omitted, or more operations may be performed than those illustrated in FIGS. 7, 8, 9B to 11.

FIG. 7 is a flowchart illustrating an operation for correcting or adjusting an image quality of a display device in a display system according to an embodiment.

Referring to FIG. 7, in operation 702, the modular display 135 may transmit display information to the control device 120. The transmission of the display information may occur either automatically upon establishing a connection with the control device 120 or in response to a request initiated by the control device 120. For example, the modular display 135 may provide display information to the control device 120 based on a connection with the control device 120, or may provide display information to the control device 120 based on a request from the control device 120. According to an embodiment, the display information may include arrangement information and/or area information related to the configuration of the modular display 135 within the display device 130. The arrangement information may define the physical or logical layout of module blocks that constitute the modular display 135. The area information may specify spatial regions or areas such as the first area 131 or the second area 132, in which individual or grouped module blocks are located.

In operation 704, the source device 110 may provide image data as source data to the control device 120. The source device 110 may provide image data to the control device 120 based on a user setting or a request from the control device 120. The source device 110 may continuously provide image data to the control device 120 after operation 704, based on a user setting, request from the control device 120, or the size or capacity of the image data.

In operation 706, the electronic device 150 may provide boundary area setting information to the control device 120. According to an embodiment, the boundary area setting information may include first information for setting the size or range (e.g., information specifying the position, dimensions, or grid structure of the boundary area, such as the number of rows and/or columns of module blocks forming the boundary area) of the boundary area between the first area 131 and the second area 132 of the screen of the display device 130, and/or second information for setting the resolution of the boundary area 133, which may involve parameters such as pixel density, aspect ratio, or scaling factors to ensure consistent display quality across adjacent regions. The boundary area setting information may be information set by a user based on a management program or a configuration program. The electronic device 150 may transmit the boundary area setting information to the control device 120 via the AP 140 based on a connection method (or communication method) with the control device 120. Operation 706 of the electronic device 150 may be conditionally performed based on a connection state between the electronic device 150 and the control device 120 or a user's input or selection. In other words, operation 706 may be optionally performed and may not always be performed. In some embodiments, the electronic device 150 may be incorporated within the control device 120, in which case internal communication (e.g., via a system bus or inter-integrated circuit (I²C) interface) may be used instead of an external transmission path.

In operation 708, the control device 120 may determine the boundary area 133. For example, the control device 120 may identify the first area 131 and the second area 132 based on the display information received in operation 702, and determine the area adjacent to the second area 132 in the first area 131 as the boundary area 133. A bordering portion of the boundary area 133 may be positioned directly next to a bordering portion of the second area 132, with no modular displays interposed between them. According to an embodiment, when receiving the boundary area setting information in operation 706, the control device 120 may determine the boundary area 133 based on the first information included in the received boundary area setting information.

In operation 710, the control device 120 may set the resolution of the boundary area 133 based on the determination of the boundary area 133. For example, the control device 120 may set the third resolution based on the first resolution of the first area 131 and the second resolution of the second area 132 as the resolution of the boundary area 133. The third resolution may indicate a resolution (e.g., an average resolution) between the first resolution and the second resolution, but the disclosure is not limited thereto. According to an embodiment, when receiving the boundary area setting information in operation 706, the control device 120 may set the resolution of the boundary area 133 based on the second information included in the received boundary area setting information.

In operation 712, the control device 120 may transmit output information including at least one of image data received from the source device 110, information about the boundary area 133, or resolution information about the boundary area 133 to the modular display 135. According to an embodiment, when the modular display 135 is not associated with the boundary area 133, the information about the boundary area 133 or the resolution information about the boundary area 133 may not be included in the output information.

In operation 714, the modular display 135 may display an image based on image data at a resolution set for the boundary area 133 based on the output information received from the control device 120. For example, the modular display 135 may identify that a portion of the first area 131 is set to the boundary area 133 based on the received output information, and downscale the resolution of the boundary area 133 to the set resolution. The modular display 135 may display an image based on image data at the downscaled resolution.

In FIG. 7, the operations in which the control device 120 determines the boundary area 133 and sets the resolution of the boundary area 133 have been described, but corresponding operations (e.g., operations 708 and 710) may be performed by the modular display 135.

According to an embodiment, the control device 120 may transmit image data received from the source device 110 to the modular display 135. The control device 120 may not perform operations 702, 708, 710, or 712.

According to an embodiment, the modular display 135 may determine the boundary area 133 based on the area information about the modular display 135. If the boundary area setting information set by the electronic device 150 is received through the control device 120, the modular display 135 may determine the boundary area 133 based on the received boundary area setting information. If the boundary area 133 is determined, the modular display 135 may set the resolution of the boundary area 133. The modular display 135 may display an image based on image data at a resolution set for the determined boundary area 133 based on the resolution set.

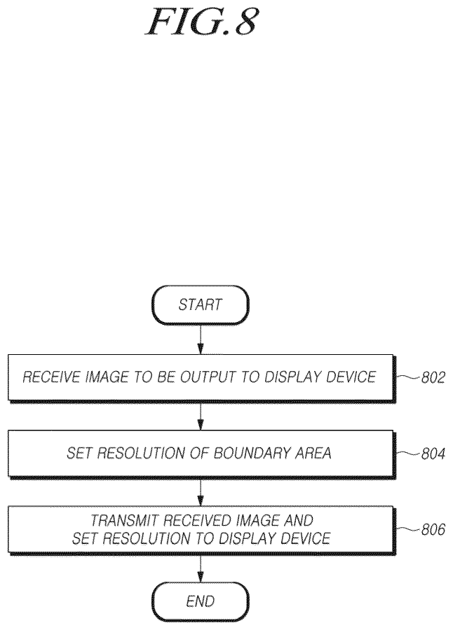

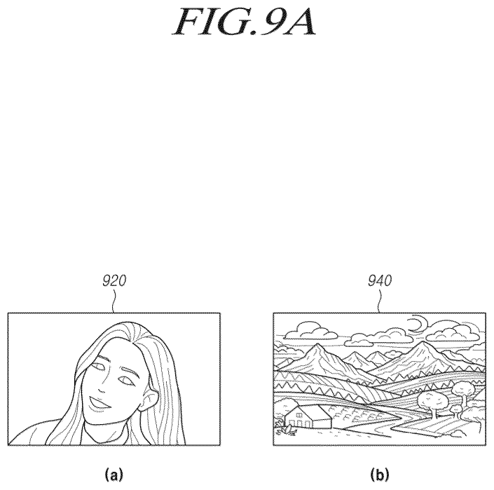

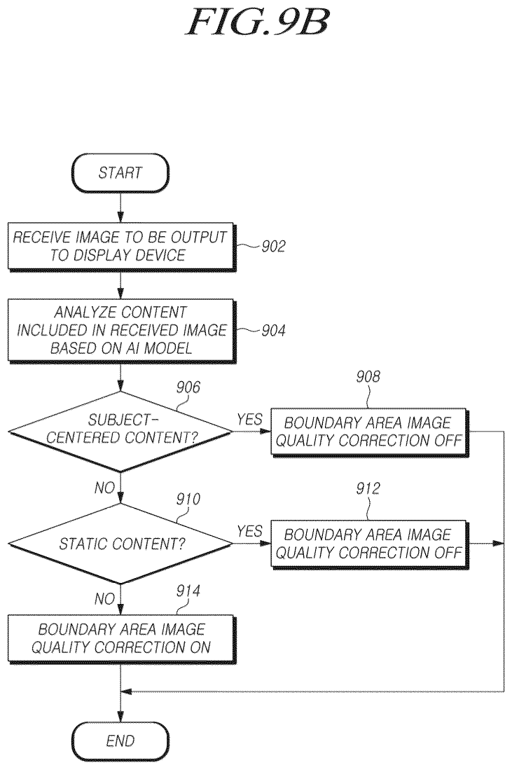

Hereinafter, operations of the control device 120 are described with reference to FIGS. 8, 9A and 9B.

FIG. 8 is a flowchart illustrating an operation of a control device according to an embodiment.

Referring to FIG. 8, in operation 802, the control device 120 may receive an image to be displayed to the display device 130 (or the plurality of modular displays) from the source device 110. According to an embodiment, the received image may include a still image, a video, a real-time streaming image, a broadcast image, text, or a combination thereof. According to an embodiment, the display device 130 may include at least two areas. The at least two areas may include areas set to different resolutions based on different pixel pitches. For example, the display device 130 may include a first area 131 set to the first resolution and a second area 132 set to the second resolution. The first area 131 and the second area 132 may be adjacent areas.

In operation 804, the control device 120 may set the resolution of the boundary area 133 between the first area 131 and the second area 132. According to an embodiment, the control device 120 may set the resolution of the boundary area 133 between the first area 131 and the second area 132 to the third resolution determined based on the first resolution of the first area 131 and the second resolution of the second area 132. According to an embodiment, by determining the third resolution based on the first and second resolutions, an image may be displayed in a natural manner on the boundary area 133, making the resolution reduction in the second area 132 may not be noticed by a user.

According to an embodiment, the operation of setting the resolution of the boundary area 133 may be included in the image quality correction operation for the boundary area 133. In addition to the resolution determination operation, the image quality correction operation of the boundary area 133 may further include additional operations such as an image processing operation, a color correction operation, or a noise removal operation for the boundary area 133.

In operation 806, the control device 120 may transmit the received image and information about the set resolution of the boundary area 133 to the display device 130. According to an embodiment, the control device 120 may transmit the received image and information about the set resolution of the boundary area 133 to at least one modular display. The at least one modular display may include at least one modular display including at least a portion of the boundary area 133 among the plurality of modular displays included in the display device 130.

FIG. 9A is an example diagram illustrating a type of content according to an embodiment.

According to an embodiment, the control device 120 may or may not perform an image quality correction operation of the boundary area 133 in consideration of the type of content included in the received image. For example, the control device 120 may set the resolution of the boundary area 133 based on the type of content included in the received image not corresponding to the set type. The set type of content may include, e.g., the first type or the second type as illustrated in image (a) or image (b) of FIG. 9A.

Referring to image (a) of FIG. 9A, the first type of content may include subject-centered content 920. The subject-centered content 920 may represent content where the subject is displayed in the first area 131 of the display device 130. The subject may include at least one of a person, an object, or an animal, but the disclosure is not limited thereto.

When the subject-centered content 920 is displayed, a user's gaze may be concentrated on the first area 131, and the second area 132 including the background may have poor visibility even when it is included in the user's field of view. Therefore, even when the image quality correction operation (e.g., a resolution determination operation) of the boundary area 133 is not performed, the reduction in resolution of the second area 132 may not be noticed by the user.

Referring to image (b) of FIG. 9A, the second type of content may include static content 940. The static content 940 may include background or landscape-oriented content with less movement. If the user's field of view is out of the vision area while the static content 940 is being displayed, the user may notice the movement, but may not notice the difference in resolution. Therefore, since the reduction in resolution of the second area 132 may not be noticed by the user, the image quality correction operation of the boundary area 133 may not be performed on the static content 940.

According to an embodiment, the set type of content may include another type in addition to the above-described first type or second type. For example, a third type associated with content including various colors and patterns, or a fourth type associated with content including a plurality of objects with similar colors, sizes, or contrast levels may be included in the set type of content.

FIG. 9B is a flowchart illustrating operations of a control device for image quality correction of a display device according to an embodiment.

Referring to FIG. 9B, in operation 902, the control device 120 may receive an image to be displayed to the display device 130 (or the plurality of modular displays) from the source device 110.

In operation 904, the control device 120 may analyze the content included in the received image based on the AI model. According to an embodiment, the AI model may include a machine learning model trained to identify a content type based on a still image or video.

In operation 906, the control device 120 may determine whether the content included in the received image is subject-centered content (e.g., the subject-centered content 920 illustrated in image (a) of FIG. 9A), based on the analysis result.

In operation 908, the control device 120 may not perform an image quality correction operation on the boundary area 133 based on the content included in the received image being subject-centered content.

In operation 910, the control device 120 may determine whether the content included in the received image is static content (e.g., static content 940 illustrated in image (b) of FIG. 9A) based on the content included in the received image being not subject-centered content.

In operation 912, the control device 120 may not perform an image quality correction operation on the boundary area 133 based on the received content included in the image being static content.

In operation 914, the control device 120 may perform an image quality correction operation on the boundary area 133 based on the received content included in the image not being static content. For example, the image quality correction operation may include an operation of determining the resolution of the boundary area 133 based on the first resolution and the second resolution. The image quality correction operation may further include at least one of an image processing operation, a color correction operation, and a noise removing operation for the boundary area 133.

According to an embodiment, operations 906 and 910 of FIG. 9 may be performed simultaneously, or operation 910 may be performed before operation 906.

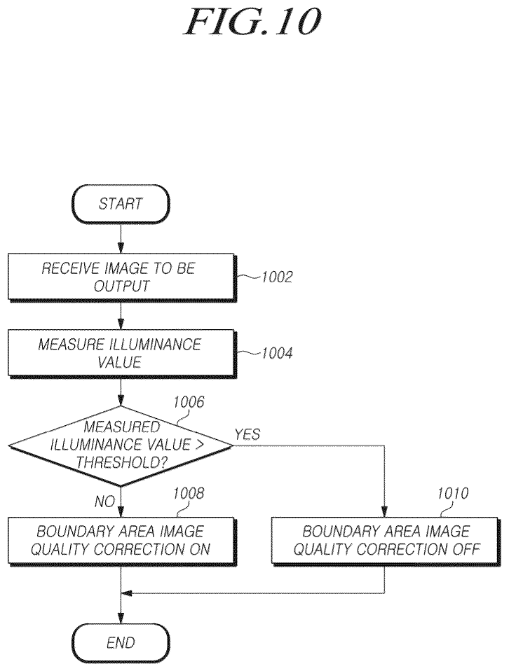

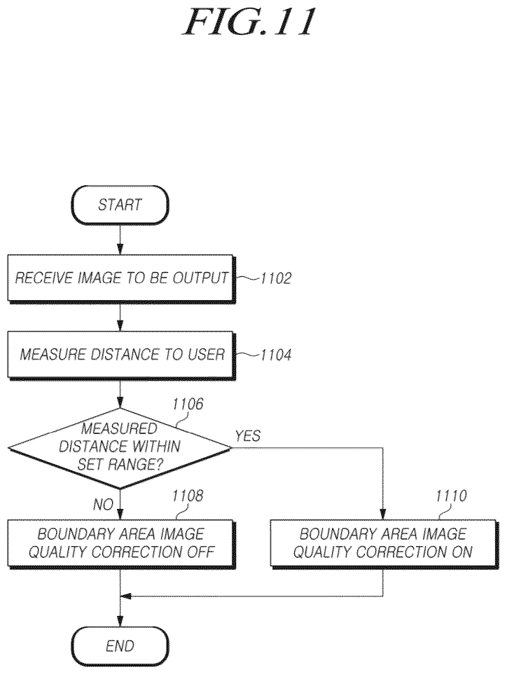

According to an embodiment, the image quality correction operation for the boundary area 133 may be performed in the modular display 135 included in the display device 130 instead of the control device 120. Hereinafter, operations of the modular display 135 are described with reference to FIGS. 10 and 11.

FIG. 10 is a flowchart illustrating operations of a modular display for image quality correction based on an illuminance value according to an embodiment.

Referring to FIG. 10, in operation 1002, the modular display 135 may receive an image to be displayed from the control device 120. The image received from the control device 120 may be an image provided by the source device 110.

In operation 1004, the modular display 135 may measure an illuminance value using the illuminance sensor 632. The measured illuminance value may be an illuminance value based on the position where the modular display 135 is installed or disposed.

In operation 1006, the modular display 135 may determine whether the measured illumination value is greater than or equal to a threshold.

In operation 1008, the modular display 135 may perform an image quality correction operation on the boundary area 133 based on the measured illumination value being less than the threshold. When the measured illuminance value is less than the threshold, the modular display 135 may identify the surrounding environment as dark. When the surrounding environment is dark, the resolution reduction for the second area 132 is highly likely to be noticed by a user, so that the modular display 135 may perform an image quality correction operation on the boundary area 133.

In operation 1010, the modular display 135 may not perform an image quality correction operation on the boundary area 133 based on the measured illumination value being greater than or equal to the threshold. The modular display 135 may identify the surrounding environment as bright when the measured illuminance value is greater than or equal to the threshold. When the surrounding environment is bright, the resolution reduction for the second area 132 is less likely to be noticed by the user, so that the modular display 135 may not perform an image quality correction operation for the boundary area 133.

FIG. 11 is a flowchart illustrating operations of a modular display for image quality correction based on a distance from a user according to an embodiment.

Referring to FIG. 11, in operation 1102, the modular display 135 may receive an image to be displayed from the control device 120. The image received from the control device 120 may be an image provided by the source device 110.

In operation 1104, the modular display 135 may measure a distance to the user (or a viewer) using the distance sensor 634.

In operation 1106, the modular display 135 may determine whether the measured distance is in a set range.

In operation 1108, the modular display 135 may not perform an image quality correction operation on the boundary area 133 based on the measured distance not being in the set range. According to an embodiment, the set range may include a range in which a distance from the modular display 135 is not too close or far away. For example, the set range may include a range based on the user's viewing distance predicted based on at least one of the installation position, installation environment, layout space, purpose of use, type of use, or characteristics of the content to be output.

In operation 1110, the modular display 135 may perform an image quality correction operation on the boundary area 133 based on the measured distance being in the set range.

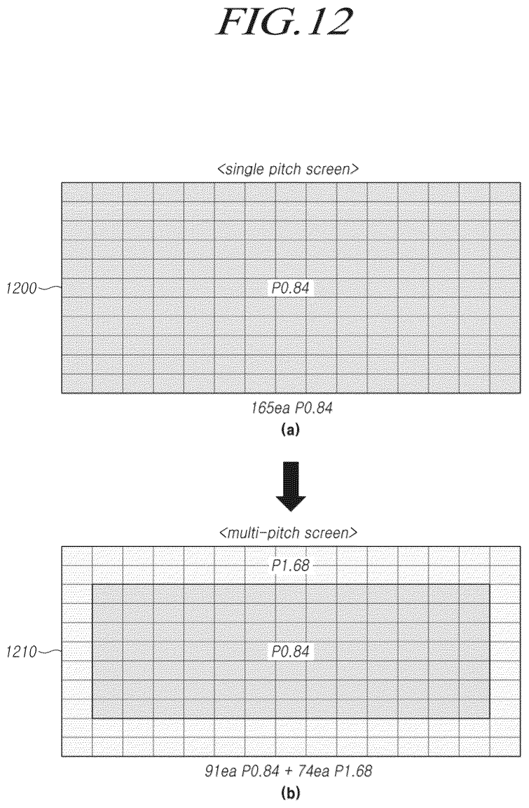

FIG. 12 is a diagram illustrating comparison between a single pitch screen and a multi-pitch screen according to an embodiment.

Referring to image (a) of FIG. 12, the single pitch screen 1200 may indicate a screen based on a single pixel pitch. For example, the single pitch screen 1200 may include 165 module blocks having a pixel pitch of P0.84 (or 0.84 mm). The pixels in the 165 module blocks all may be disposed at the same spacing based on P0.84.

Referring to image (b) of FIG. 12, the multi-pitch screen 1210 may indicate a screen based on at least two pixel pitches. For example, the multi-pitch screen 1210 may include 91 first module blocks with a pixel pitch of P0.84 (or 0.84 mm) and 74 second module blocks with a pixel pitch of P1.68 (or 1.68 mm). The pixels in the 91 first module blocks may be disposed at a first spacing based on P0.84, and the pixels in the 74 second module blocks may be disposed at a second spacing based on P1.68. The first spacing may be smaller than the second spacing. The multi-pitch screen 1210 may correspond to the screen of the above-described display device 130.

The use of the multi-pitch screen 1210 instead of the single pitch screen 1200, offers technical and economic advantages, as shown in Table 1 below.

TABLE 1

| | Single pitch | Multi-pitch | |
|---|---|---|---|
| Model | screen | screen | Effects |
| Model A | $1,279,575 | $935,771 | Save by 26.8% |
| Model B | $1,297,560 | $953,830 | Save by 26.5% |

Referring to Table 1, adopting the multi-pitch screen 1210 leads to a substantial reduction in installation cost for both Model A and Model B, 26.8% and 26.5% respectively, while preserving visual performance in critical viewing zones. Specifically, if the display device of model A is configured with a single pitch screen 1200, a cost of $1,279,575 may be incurred, and if it is configured with a multi-pitch screen 1210, a cost of $935,771 may be incurred. Since at least one modular display having a relatively low resolution, which is relatively inexpensive, may be disposed in the second area (an area with a pixel pitch of P1.68) of the multi-pitch screen 1210, when the display device is configured with the multi-pitch screen 1210, the cost may be saved by 26.8%. In the case of model B, a cost of $1,297,560 may be incurred if the display device is configured with a single pitch screen 1200, and a cost of $953,830 may be incurred if the display device is configured with a multi-pitch screen 1210. Since at least one relatively inexpensive modular display may be disposed in model B, when the display device is configured with the multi-pitch screen 1210, the cost may be saved by 26.5%.

This cost efficiency is achieved through a technically optimized configuration, in which the display area is segmented based on viewing priority. In lower-priority viewing zones, such as the second area (e.g., with pixel pitch P1.68), the multi-pitch screen enables the integration of modular displays with a relatively lower resolution that are more cost-effective than uniformly high-resolution panels. This hybrid configuration allows for precise allocation of high-resolution modules where needed (e.g., areas requiring high pixel density for close-range viewing), while utilizing lower-cost, lower-resolution modules in peripheral areas without compromising the overall viewing experience. In addition, when the boundary area correction operation is applied, the transition between different pixel pitches is visually seamless, preserving consistent image quality image quality across the entire screen. As a result, the multi-pitch screen 1210 not only reduces costs but also enhances system flexibility and scalability.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

According to various embodiments, each component (e.g., a module or a program) of the above-described components may include a single entity or multiple entities. Some of the plurality of entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

What is claimed is:

1. An electronic device comprising:
a transceiver;
memory; and
at least one processor,
wherein the at least one processor is configured to execute instructions stored in the memory to:
receive an image via the transceiver, to be displayed on a display device comprising a first display area set to a first resolution and a second display area set to a second resolution;
set a resolution of a boundary area between the first display area and the second display area to a third resolution based on the first resolution and the second resolution; and
transmit the received image and information about the third resolution to the display device,
wherein the first resolution is set based on a first pixel pitch of the first display area,
the second resolution is set based on a second pixel pitch of the second display area, and
the second pixel pitch is different from the first pixel pitch.

2. The electronic device of claim 1, wherein the first pixel pitch is less than the second pixel pitch,
the first display area is determined based on at least one of a screen size of the display device, a viewing angle of a user viewing the display device, or a viewing distance of the user, and
the second display area is determined to be a remaining area except for the first display area in a screen of the display device.

3. The electronic device of claim 1, wherein the display device comprises a plurality of modular displays, and
the plurality of modular displays are included in the first display area and the second display area.

4. The electronic device of claim 1, wherein the at least one processor is configured to execute the instructions to:
identify a content type of content included in the received image by analyzing the received image based on a machine learning model that is trained to identify the content type based on a still image or a video; and
set the resolution of the boundary area to the third resolution based on the content type not corresponding to a set type,
wherein the set type indicates content having a subject positioned at a center of a screen of the display device or content associated with static imagery.

5. The electronic device of claim 1, wherein the at least one processor is configured to execute the instructions to:
determine an area within the first display area, adjacent to the second display area, as the boundary area; and
control the transceiver to transmit, to at least one modular display of the display device, information about the determined boundary area, the received image, or information about the third resolution, and
wherein the at least one modular display comprises at least a portion of the boundary area among a plurality of modular displays included in the display device.

6. The electronic device of claim 1, wherein the at least one processor is configured to set an average resolution of the first resolution and the second resolution as the third resolution.

7. A display device, comprising:
a transceiver;
a plurality of modular displays configured to form a first display area set to a first resolution and a second display area set to a second resolution;
memory; and
at least one processor;
wherein the at least one processor is configured to execute instructions stored in the memory to:
receive output information from an electronic device via the transceiver;
based on first information included in the output information, identify a third resolution set for a boundary area between the first display area and the second display area; and
control the display to display an image corresponding to second information included in the output information in the boundary area at the third resolution,
wherein the third resolution is determined based on the first resolution and the second resolution,
the first resolution is set based on a first pixel pitch of the first display area,
the second resolution is set based on a second pixel pitch of the second display area, and
the second pixel pitch is different from the first pixel pitch.

8. The display device of claim 7, further comprising a first sensor, wherein the at least one processor is configured to execute the instructions to:
measure an illuminance value based on the first sensor, based on receiving the output information; and
control the display to display the image corresponding to the second information in the boundary area at the third resolution based on the measured illuminance value being less than a threshold.

9. The display device of claim 7, further comprising a second sensor, wherein the at least one processor is configured to execute the instructions to:
measure a distance from a user based on the second sensor, based on receiving the output information; and
control the display to display the image corresponding to the second information included in the output information in the boundary area at the third resolution based on the measured distance being included in a set range.

10. The display device of claim 7, wherein the first pixel pitch is less than the second pixel pitch,
the first display area is determined based on at least one of an entire screen size of the modular display device, a viewing angle of a user viewing the modular display device, or a viewing distance of the user, and
the second display area is determined to be a remaining area except for the first display area in an entire screen of the modular display device.

11. A method for operating an electronic device, the method comprising:
receiving an image to be displayed on a display device from a source device, the display device comprising a first display area set to a first resolution and a second display area set to a second resolution;
setting a resolution of a boundary area between the first display area and the second display area to a third resolution determined based on the first resolution and the second resolution; and
transmitting the received image and information about the third resolution to the display device,
wherein the first resolution is set based on a first pixel pitch of the first display area,
the second resolution is set based on a second pixel pitch of the second display area, and
the second pixel pitch is different from the first pixel pitch.

12. The method of claim 11, wherein the first pixel pitch is less than the second pixel pitch,
the first display area is determined based on at least one of a screen size of the display device, a viewing angle of a user viewing the display device, or a viewing distance of the user, and
the second display area is determined to be a remaining area except for the first display area in a screen of the display device.

13. The method of claim 11, wherein the display device comprises a plurality of modular displays, and
the plurality of modular displays are included in the first display area and the second display area.

14. The method of claim 11, wherein the setting of the resolution of the boundary area to the third resolution comprises:
identifying a content type of content included in the received image by analyzing the received image based on a machine learning model that is trained to identify the content type based on a still image or a video; and
setting the resolution of the boundary area to the third resolution based on the content type not corresponding to a set type, and
wherein the set type indicates content having a subject positioned at a center of a screen of the display device or content associated with static imagery.

15. The method of claim 11, further comprising:
determining an area within the first display area, adjacent to the second display area, as the boundary area; and
transmitting, to at least one modular display of the display device, information about the determined boundary area, the received image, or information about the third resolution,
wherein the at least one modular display comprises at least a portion of the boundary area among a plurality of modular displays included in the display device.

16. The method of claim 11, wherein the setting of the resolution of the boundary area to the third resolution comprises setting an average resolution of the first resolution and the second resolution as the third resolution.

17. A method for operating a display device, the method comprising:
receiving output information from an electronic device, the display device comprising a plurality of modular displays that configure a first display area set to a first resolution and a second display area set to a second resolution;
based on first information included in the output information, identifying a third resolution set for a boundary area between the first display area and the second display area; and
displaying an image corresponding to second information included in the output information in the boundary area at the third resolution,
wherein the third resolution is determined based on the first resolution and the second resolution,
the first resolution is set based on a first pixel pitch of the first display area,
the second resolution is set based on a second pixel pitch of the second display area, and
the second pixel pitch is different from the first pixel pitch.

18. The method of claim 17, wherein the identifying of the third resolution comprises:
measuring an illuminance value based on a first sensor included in the display device, based on receiving the output information; and
displaying the image corresponding to the second information in the boundary area at the third resolution based on the measured illuminance value being less than a threshold.

19. The method of claim 17, wherein the identifying of the third resolution comprises:
measuring a distance from a user based on a second sensor included in the display device, based on receiving the output information; and
displaying the image corresponding to the second information in the boundary area at the third resolution based on the measured distance being included in a set range.

20. The method of claim 17, wherein the first pixel pitch is less than the second pixel pitch,
the first display area is determined based on at least one of an entire screen size of the display device, a viewing angle of a user viewing the display device, or a viewing distance of the user, and
the second display area is determined to be a remaining area except for the first display area in an entire screen of the display device.
